(19) United States
(12) Patent Application Publication
(10) Pub. No.: US 2004/0014863 A1
(43) Pub. Date: Jan. 22, 2004

(54) Uv-resistant hot-melt contact adhesive, a method for producing the same and adhesive objects produced therefrom

(76) Inventors: Nobert Lorenz, Duesseldorf (DE); Stephen Hatfield, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 10/312,370

(22) PCT Filed: Jun. 15, 2001
(86) PCT No.: PCT/EP01/06812

(30) Foreign Application Priority Data
Jun. 23, 2000 (DE) 100 30 683.7

(51) Int. Cl. C08K 3/18; C08K 3/22

(52) U.S. Cl. 524/430; 524/497

(57) ABSTRACT

The invention relates to a hot-melt contact adhesive, containing at least one unsaturated polymer and a particulate inorganic compound which has an average particle diameter d50 of between 0.05 and 300 μm. The invention also relates to a method for producing the same and to the use of inorganic particulate compounds of this type for producing a hot-melt contact adhesive. In addition, The invention relates to adhesive objects which are produced using a hot-melt contact adhesive of this type.

This invention relates to a pressure-sensitive hotmelt adhesive at least containing an unsaturated polymer and a particulate inorganic compound, the particulate inorganic compound having a mean particle diameter d50 of 0.05 to 300 μm, to a process for its production in which at least one unsaturated polymer and a particulate inorganic compound as just defined are mixed and to pressure-sensitive adhesive articles produced using the pressure-sensitive hotmelt adhesive. The present invention also relates to the use of particulate inorganic compounds with a mean particle diameter d50 of 0.05 to 300 μm for the production of pressure-sensitive hotmelt adhesives.

Pressure-sensitive hotmelt adhesives are commonly used in many areas for bonding various materials both in the industrial manufacture of consumer and capital goods and in the private sector. One advantage of pressure-sensitive hotmelt adhesives is, for example, that they can be applied from the melt to a corresponding substrate and, after solidifying, generally enter into a firm bond with the substrate. Typically, pressure-sensitive hotmelt adhesives can be applied without water-based or organic solvents, the pressure-sensitive hotmelt adhesive after solidifying having a firm adhesive surface with pressure-sensitive adhesive properties.

The adhesive strength that comes from the pressure-sensitive adhesiveness with which pressure-sensitive hotmelt adhesives are left after solidification depends on the one hand on the compatibility between the pressure-sensitive hotmelt adhesive and the substrate to which it is to be applied, i.e. on the adhesion between the pressure-sensitive hotmelt adhesive and the substrate. On the other hand, however, the adhesive strength is also based on the cohesion of the pressure-sensitive hotmelt adhesive itself. Even minor changes in the composition of the pressure-sensitive hotmelt adhesive or in its molecular structure can produce a drastic reduction in adhesive strength and can thus make the pressure-sensitive hotmelt adhesive unusable from the outset or can weaken or even totally destroy a bonded joint made with the pressure-sensitive hotmelt adhesive.

Accordingly, it is important even at the formulation stage of the pressure-sensitive hotmelt adhesive to ensure that individual components introduced into the pressure-sensitive hotmelt adhesive do not adversely affect the adhesive strength of the pressure-sensitive hotmelt adhesive. In addition, a bonded joint made with a pressure-sensitive hotmelt adhesive can lose its adhesive strength over a certain period as a result of environmental influences and hence changes in the molecular structure of the pressure-sensitive hotmelt adhesive to such an extent that a firm bond between two parts can no longer be guaranteed.

The influence of light and particularly ultraviolet radiation (UV radiation) has proved to be particularly harmful to the long-term behavior of the adhesive strength of pressure-sensitive hotmelt adhesives. The binder molecules which make a majority contribution to the composition of a pressure-sensitive hotmelt adhesive can contain functional groups which interact with light and particularly UV light. The energy absorbed by one such functional group can lead to oxidation, crosslinking, an increase in molecular weight through further polymerization, a reduction in molecular weight through depolymerization and a number of other reactions which alter the molecular structure of the pressure-sensitive hotmelt adhesive. As a result, the pressure-sensitive hotmelt adhesive can lose flexibility, cohesion or adhesion or one or more other important properties. It is essential to ensure, particularly when a pressure-sensitive hotmelt adhesive is to be used in the open, that such molecular changes which lead to a loss of adhesive strength occur to only an unavoidably minimal extent, if at all.

This need has resulted in the proposal of various possibilities for imparting improved long-term stability, even under the influence of UV light, to bonded joints made in the open using pressure-sensitive hotmelt adhesives.

For example, U.S. Pat. No. 5,204,390 describes a pressure-sensitive hotmelt adhesive which is said to have improved resistance to UV radiation. To this end, the document in question proposes a pressure-sensitive hotmelt adhesive which contains a tackifier, a plasticizer in the form of an end-capped polybutene and a substantially saturated thermoplastic resin with a molecular weight of up to about 200,000. However, the disadvantage of the described pressure-sensitive hotmelt adhesives is that the saturated thermoplastic resins used in them only show unsatisfactory adhesion to many substrates. In addition, according to the teaching of the document in question, compounds containing olefinically unsaturated groups, as are typically used in pressure-sensitive hotmelt adhesives, have to be subjected to a treatment to convert the olefinically unsaturated groups into saturated groups so that the described pressure-sensitive hotmelt adhesive is substantially free from olefinically unsaturated groups.

EP-A 0 636 654 relates to a hotmelt adhesive which contains a linear styrene/isoprene/styrene triblock copolymer and a stabilizer composition containing one or more UV stabilizers and at least one phosphite antioxidant. Organic stabilizers are mentioned as UV stabilizers. However, the disadvantage of the described hotmelt adhesives is that, in order to obtain a UV-stabilizing effect so that the hotmelt adhesive may also be used outdoors, large quantities of organic UV stabilizers have to be used.

JP 58176283 (Derwent Abstract No. 83824085) relates to an aqueous dispersion of a copolymer obtainable by copolymerization of a diene monomer with at least one alkyl methacrylate monomer. The dispersion contains 1 to 50% by weight (based on solids) of titanium dioxide. However, the document in question does not describe a pressure-sensitive hotmelt adhesive.

78 JP-047891 (Derwent Abstract No. 7988618B) describes an adhesive containing a thermoplastic resin and a UV stabilizer, for example titanium dioxide. The adhesive may also contain 0.2 to 1.3% by weight of an antioxidant as an optional ingredient. A pressure-sensitive hotmelt adhesive is not mentioned.

Accordingly, the problem addressed by the present invention was to provide pressure-sensitive hotmelt adhesives which would provide a bonded joint made with the adhesive with improved long-term UV stability. Another problem addressed by the present invention was to provide pressure-sensitive hotmelt adhesives which, despite a content of olefinically unsaturated double bonds, would contain no organic UV stabilizers at all or at least a reduced content of organic UV stabilizers. A further problem addressed by the present invention was to provide a process for the production of such pressure-sensitive hotmelt adhesives and pressure-sensitive adhesive articles comprising a pressure-sensitive hotmelt adhesive according to the invention.

The problems stated above are solved by a pressure-sensitive hotmelt adhesive, by a process for its production and by a pressure-sensitive adhesive article produced using a pressure-sensitive hotmelt adhesive according to the invention, as described in the following text.

Accordingly, the present invention relates to a pressure-sensitive hotmelt adhesive at least containing a polymer with at least one olefinically unsaturated C—C double bond and a particulate inorganic compound, the particulate inorganic compound having a mean particle diameter d50 of 0.05 to 300 μm.

A “pressure-sensitive hotmelt adhesive” in the context of the present invention is a substance which is substantially solid at room temperature, i.e. remains dimensionally stable over a prolonged period in the absence of any external application of force, and which melts on heating to a temperature above at least about 0° C., preferably at least about 10° C. or at least about 20° C. or to a temperature within a certain range above the temperature mentioned, the substance having pressure-sensitive adhesive properties at least in its solid state, but for example also in its molten state.

The pressure-sensitive hotmelt adhesive according to the invention contains at least one polymer which contains at least one olefinically unsaturated C—C double bond. Suitable such polymers are both homopolymers and copolymers. The copolymers may be both statistical copolymers and block copolymers.

In a preferred embodiment of the present invention, polymers with a molecular weight of at least about 5,000 and preferably of at least about 10,000 are used in the pressure-sensitive hotmelt adhesive according to the invention. The upper limit to the molecular weight of the polymers suitable for use in accordance with the invention is about 1,000,000 although actual upper limits of about 500,000 or lower, for example about 200,000, 180,000, 160,000, 140,000, 120,000 or about 100,000 are preferred. Suitable polymers can have molecular weights between the limits mentioned, for example about 20,000, 40,000, 60,000 or 80,000. The figures quoted represent the number average molecular weight which can be determined, for example, by gel permeation chromatography (GPC) under typical conditions against polystyrene as standard.

In a preferred embodiment of the present invention, block copolymers are used as the polymers. According to the invention, the number of blocks in such copolymers is 2 to about 10, for example 2 to 5 and more particularly 2 or 3. A section of a polymer referred to as a block in the context of the invention may consist of only one monomer. However, it is also within the scope of the present invention for an individual block to contain a statistical sequence of two or more monomer units. Two blocks of the polymers suitable for use in accordance with the invention may differ solely in the weighting of the monomers involved in an individual block although they may also differ in a completely different composition of the monomeric structural components of the blocks.

The compounds suitable for use as polymers for the purposes of the present invention may have, for example, a block structure which, in regard to the nature of its monomer composition, may be described by different letters, for example A-B-C-D . . . . Different letters signify a different monomer composition. However, it is also possible in the context of the present invention for the polymers used in accordance with the invention to have a completely or partly repeating sequence of blocks, for example A-B-A.

A preferred embodiment of the present invention is distinguished by the use of polymers which have a sequence of monomers characterizable by the sequence of letters A-B or A-B-A.

Suitable monomers which make up the polymers used in accordance with the invention are, for example, aromatic vinyl monomers, such as styrene and substituted analogs thereof, for example α-methylstyrene, or nucleus-substituted styrene derivatives, suitable substituents being, for example, linear or branched alkyl groups as in o-methylstyrene, p-methylstyrene, p-tert.butyl methylstyrene or 1,3-dimethylstyrene, alkoxy groups or halogens. 1,2-Unsaturated alkenes, such as ethylene, propylene or butylene, are also suitable. Compounds containing at least two olefinically unsaturated double bonds are particularly suitable for use in, or for partial use in, the production of the polymers usable in accordance with the invention. Such compounds are, in particular, isobutene, butadiene, isoprene, 2,3-dimethyl-1,3-butadiene, 1,3-pentadiene or 1,3-hexadiene. As already mentioned, the named monomers may be used for the production of homopolymers or copolymers. The monomers named above may be used both individually and in the form of mixtures of two or more of the monomers mentioned.

In a preferred embodiment of the invention, the polymers used are block copolymers which contain at least one block made up of styrene units or units predominantly obtainable by polymerization of styrene or styrene derivatives and at least one other block obtainable by polymerization of monomers with at least two olefinically unsaturated double bonds, such a polymer having at least one olefinically unsaturated double bond. In another preferred embodiment of the invention, the polymers used are block copolymers with an A-B-A structure or an A-B structure, the A block being made up essentially of styrene monomers and the B block being obtainable at least partly, but preferably largely from isoprene or butadiene monomers. In another preferred embodiment of the invention, a block B may contain one or more comonomers besides butadiene or isoprene monomers. In this case, ethylene, propylene or butylene, for example, is used as comonomer in the production of such a block.

The polymers used in accordance with the invention in the pressure-sensitive hotmelt adhesive according to the invention have a glass transition temperature (T_{g}) of about −100 to about 50° C. If a block copolymer is used as the polymer, it is of advantage if the various blocks which contribute to the synthesis of the block copolymer have different glass transition temperatures. In a preferred embodiment of the present invention, the blocks A and B in the above-mentioned A-B-A block copolymers or in the A-B block copolymers are adjusted in such a way that a block A has a glass transition temperature of about 60 to about 130° C. and more particularly in the range from about 75 to about 110° C.

Suitable blocks B which, for example, may contain at least one olefinically unsaturated double bond have glass transition temperatures in the range from about −120 to about −20° C. If, for example, blocks based on butadiene monomers are used as the blocks B, these blocks have a glass transition temperature of, in particular, about −120 to about −60° C. If, for example, blocks based on isoprene monomers are used as the blocks B, these blocks have a glass transition temperature of, in particular, about −90 to about −20° C.

If block copolymers are used as polymers for the purposes of the present invention, it has proved to be of advantage for a block A at least predominantly based on styrene or styrene derivatives to have a molecular weight of about 1,000 to about 25,000, for example in the range from about 5,000 to about 15,000. In a preferred embodiment of the present invention, corresponding blocks B based at least partly on isoprene or butadiene have a molecular weight of about 40,000 to about 300,000, for example in the range from about 80,000 to about 250,000 or in the range from about 100,000 to about 200,000.

The polymers and particularly block copolymers used in accordance with the present invention in the corresponding pressure-sensitive hotmelt adhesives may be prepared in known manner by radical or ionic polymerization processes. If the polymer used in a pressure-sensitive hotmelt adhesive according to the invention is a block copolymer, it may advantageously be produced by ionic polymerization. To produce an A-B-A triblock copolymer, for example, an aromatic vinyl monomer, for example styrene, may first be reacted substantially completely in an inert hydrocarbon solvent in the presence of an ionic initiator, for example an organic Li compound. A monomer containing a conjugated double bond, for example butadiene or isoprene, may then be added. The whole is then reacted until polymerization is substantially complete. To produce a last block in the block copolymer, an aromatic vinyl monomer, for example styrene or a styrene derivative, may again be added. After this compound has also been completely reacted, the polymerization may be terminated by addition of a suitable terminator. Suitable terminators are, in particular, primary or secondary alcohols, for example methanol, ethanol, 2-ethylhexanol, or monoepoxy compounds, such as ethylene oxide, propylene oxide or phenyl glycidyl ether.

Suitable solvents for the production of such block copolymers are, for example, cyclohexane, cyclopentane or mixtures thereof. Linear or branched alkanes containing 5 to 7 carbon atoms, for example n-hexane, isopentane or n-pentane, may also be present in small quantities in the solvent mixture. Cyclohexane, cyclohexane/n-hexane mixtures, cyclohexane/isopentane/n-hexane mixtures and cyclopentane and cyclopentane/isopentane mixtures are particularly suitable.

Besides the above-mentioned polymers containing at least one olefinically unsaturated group, the pressure-sensitive hotmelt adhesive according to the invention may also contain one or more other polymers including, for example, saturated or olefinically unsaturated polymers obtainable by radical or ionic polymerization of olefinically unsaturated monomers. Particularly suitable other polymers are polymers obtainable by polymerization of acrylic or methacrylic acid or derivatives thereof, more particularly esters with C₁₋₆ monoalcohols, or by polymerization of vinyl acetate, optionally with another olefinically unsaturated comonomer.

Other suitable constituents of the pressure-sensitive hotmelt adhesive according to the invention are polymers obtainable by polycondensation or polyaddition of suitable monomers. Examples of such polymers are polyethers, polyesters, polyamides, polyurethanes, silicones or polyolefins, for example polyethylene or polypropylene or copolymers thereof.

The pressure-sensitive hotmelt adhesive according to the invention contains about 10 to about 80% by weight, for example about 15 to about 70% by weight or about 20 to about 60% by weight, of the unsaturated polymer or a mixture of two or more of the unsaturated polymers mentioned above.

Besides the polymers described above or two or more of the polymers described above, the pressure-sensitive hotmelt adhesive according to the invention also contains at least one particulate inorganic compound with a mean particle diameter d50 of 0.05 to 300 μm.

Suitable particulate inorganic compounds are, for example, metal oxides, carbonates, sulfates or hydroxides which are stable under the conditions under which the pressure-sensitive hotmelt adhesive according to the invention is processed and used, i.e. do not undergo any chemical or physical changes which would be an obstacle to the use of the corresponding metal oxides in the pressure-sensitive hotmelt adhesives according to the invention and, in addition, do not enter into any interactions that could adversely affect the properties determining the pressure-sensitive hotmelt adhesive. Suitable particulate inorganic compounds are, for example, TiO₂, SnO₂, PbO₂, SiO₂ (stishovite), MnO₂, MgF₂, GeO₂, NbO₂, ZnO₂, CaCO₃, MgO, CaO or carbon black.

In a preferred embodiment of the present invention, TiO₂ or SnO₂ or ZnO₂ is used as the particulate inorganic compound.

In a preferred embodiment of the present invention, the particulate inorganic compound has a rutile structure for a crystal structure.

The particulate inorganic compounds used in accordance with the invention may consist, for example, entirely, i.e. to 100%, of the compounds mentioned above. However, compounds of which only about 70, about 80 or about 90% or more consist of the above-mentioned compounds may also be used as the particulate inorganic compound. Besides the above-mentioned compounds, the particulate inorganic compounds may also contain, for example, aluminium, silicon, manganese, antimony or zirconium or salts or oxides thereof.

In a preferred embodiment of the present invention, TiO₂ is used as the particulate inorganic compound, the TiO₂ content, based on the particulate inorganic compound, being at least about 75% by weight. The Al₂O₃ content of such a compound is preferably less than about 6.5% by weight. The SiO₂ content is preferably less than about 11% by weight, based on the particulate inorganic compound.

The particle size d50 of the particulate inorganic compound used in accordance with the invention is preferably in the range from about 0.1 to about 200 μm, for example in the range from about 0.5 to about 100 μm or in between. Suitable particle sizes are, for example, 0.25 to about 10 μm, for example 0.3 to about 5 μm. A suitable upper limit to the particle size may even be below the value mentioned, for example 4, 3, 2 or 1 μm.

The particle size may be determined by generally known methods of measurement, for example by sieving, sedimentation or light scattering.

According to the invention, TiO₂ types as marketed by DuPont under the names of R-700, R-900, R-902, R-706, R-960 or R-931 are particularly suitable. Also suitable are the TiO₂ types marketed by Kronos, for example the types 1001, 1014, 1071, 1074, 1075, 1077, 1080, 1171, 2044, 2047, 2056, 2059, 2063, 2063S, 2160, 2190, 2300, 2310, 2073, 2220, 2222, 2230, 2250, 2257, 2400, 2080, 2081, 2084, 2087, 2000 or 3025. According to the invention, the compounds mentioned may be used in the pressure-sensitive hotmelt adhesive according to the invention either individually or in the form of a mixture of two or more of the compounds mentioned.

The pressure-sensitive hotmelt adhesive according to the invention contains the particulate inorganic compound or the mixture of two or more particulate inorganic compounds in a quantity of preferably about 0.01 to about 15% by weight and more particularly in a quantity of about 0.1 to about 10% by weight. In a preferred embodiment of the present invention, the quantity of particulate inorganic compound or the total quantity of mixture of two or more particulate inorganic compounds in the pressure-sensitive hotmelt adhesive according to the invention is less than about 5% by weight, for example about 0.2 to about 2% by weight. In another preferred embodiment of the present invention, the percentage content of particulate inorganic compound in the pressure-sensitive hotmelt adhesive according to the invention is less than about 1.5% by weight or under, for example less than 1.4% by weight, less than 1.3% by weight, less than 1.2% by weight or less than 1.1% by weight. In special cases, it has been found to be of advantage for the percentage content of particulate inorganic compound or mixture of two or more particulate inorganic compounds to be less than 1% by weight, for example less than 0.9% by weight. Suitable quantities of particulate inorganic compound can be, for example, about 0.3 to about 0.85% by weight, for example about 0.75% by weight. All these figures are based on the total weight of the pressure-sensitive hotmelt adhesive.

Besides the constituents mentioned above, the pressure-sensitive hotmelt adhesives according to the invention may contain other constituents typically encountered in pressure-sensitive hotmelt adhesives such as, for example, tackifiers, plasticizers, stabilizers, waxes, antioxidants and organic UV stabilizers.

Suitable tackifiers are, for example, hydrocarbon resins, synthetic polyterpenes, resin esters and natural terpenes which are at least highly viscous, but preferably dimensionally stable at room temperature. The melting or softening temperature of such tackifiers should be in the range from about 70° C. to about 135° C. and preferably in the range from about 85° C. to about 120° C. Examples of suitable tackifier resins are natural and modified rosins, such as gum rosin, wood rosin, tall oil resin, distilled resins, hydrogenated resins, dimerized or polymerized resins, glycerol and pentaerythritol esters of natural and modified resins, such as the glycerol esters of wood rosin, the glycerol esters of hydrogenated rosin, the glycerol esters of polymerized rosin, the pentaerythritol esters of hydrogenated rosin and phenol-modified pentaerythritol esters of rosin, copolymers and terpolymers of natural terpenes, for example styrene/terpene and α-methylstyrene/terpene copolymers, polyterpene resins with a softening point, as determined by ASTM Method E28-58T, of about 80 to about 150° C., corresponding polyterpene resins normally being obtainable by the polymerization of terpene hydrocarbons, such as pinene, at low temperatures in the presence of Friedel-Crafts catalysts, and the hydrogenation products of such polyterpene resins, phenol-modified terpene resins and hydrogenated derivatives thereof, for example a resin product obtainable by condensation of a bicyclic terpene and a phenol in acidic medium, aliphatic hydrocarbons with a ball-and-ring softening point of about 70 to about 135° C. obtainable, for example, by polymerization of monomers consisting essentially of olefins and diolefins and hydrogenation products thereof. Other suitable tackifier resins are aromatic hydrocarbon resins and mixed aromatic and aliphatic hydrocarbon resins and hydrogenated derivatives thereof. Alicyclic hydrocarbon resins and hydrogenated derivatives thereof may also be used as tackifier resins.

The percentage content of tackifiers in the pressure-sensitive hotmelt adhesive according to the invention is about 10 to about 80% by weight, for example about 20 to about 75% by weight, based on the total weight of the pressure-sensitive hotmelt adhesive.

Suitable plasticizers are, for example, oligomeric and polymeric low molecular weight olefins and vegetable and animals fats and oils and derivatives thereof. Plasticizers derived from petroleum-based substances are generally compounds with a high melting point which normally have only a small percentage content, preferably less than 30% by weight or less than 15% by weight, based on the total weight of the oil, of aromatic hydrocarbons. An oil substantially free from aromatic constituents may also be used as the plasticizer.

Suitable oligomeric or polymeric plasticizers are, for example, polypropylene, polybutylene, hydrogenated isoprene, hydrogenated polybutadiene, polypiperylene or copolymers of piperylene and isoprene or the like. Suitable oligomeric or polymeric plasticizers have a molecular weight of about 300 to about 10,000. Vegetable or animal oils, for example the glycerol esters of typical fatty acids and polymerization products thereof, are also suitable.

The plasticizers may be present in the pressure-sensitive hotmelt adhesive according to the invention in a quantity of up to about 35% by weight. In a preferred embodiment of the invention, the pressure-sensitive hotmelt adhesive contains about 0.1 to about 20% by weight, for example about 0.5 to about 15% by weight or 1 to about 10% by weight, of plasticizer.

In addition, the pressure-sensitive hotmelt adhesive according to the invention may contain waxes in a quantity of up to about 15% by weight, for example about 0.5 to about 7% by weight. Suitable waxes are, for example, polyethylene waxes or synthetic paraffin waxes.

Besides the compounds already mentioned, a pressure-sensitive hotmelt adhesive according to the invention may also contain organic stabilizers. “Organic stabilizers” in the context of the present invention are understood to be compounds which protect the components of the pressure-sensitive hotmelt adhesive against heat- or oxidation-induced changes or against changes induced by the effect of high-energy radiation. According to the invention, suitable organic stabilizers are compounds which offer protection against heat-induced or oxidation-induced or radiation-induced changes. However, compounds which offer protection against two or more of the indications mentioned are equally suitable.

Suitable stabilizers are, for example, 2-(hydroxypropyl)-benzotriazole, 2-hydroxybenzophenone, alkyl-2-cyano-3-phenylcinnamate, phenylsalicylate or 1,3,5-tris-(2′-hydroxyphenyl)-triazine. Antioxidants of the Irganox® series which are marketed by Ciba-Geigy (now Novartis) are also suitable, as are distearyl pentaerythritol diphosphate compounds, for example Weston® 617 from Borg Warner Chemicals. The following compounds, for example, are also suitable stabilizers: the octadecyl ester of 3,5-bis-(1,1-dimethylethyl)-4-hydroxybenzyl propanoic acid (Irganox® 1076), 2,4-bis-(n-octylthio)-6-(4-hydroxy-3,5-di-tert.butylanilino)-1,3,5-triazine (Irganox® 565), 2-tert.butyl-6-(3-tert.butyl-2-hydroxy-5-methylbenzyl)-4-methylphenyl acrylate (Sumilizer GM), phosphite antioxidants, such as tris-(nonylphenyl)-phosphite (TNPP), tris-(monononylphenyl)-phosphite and tris-(dinonylphenyl)-phosphite (Polygard HR), bis-(2,4-di-tert.butylphenyl)-pentaerythritol diphosphite (Ultranox 626), tris-(2,4-di-tert.butylphenyl)-phosphite (Irgafos 168) and combinations of two or more of the compounds mentioned above.

According to the invention, particularly suitable light stabilizers (UV stabilizers) are, for example, light stabilizers of the Tinuvin® series, more particularly bis-(2,2,6,6-tetramethyl-4-piperidyl)-sebacate (Tinuvin 770 DF) or 2-(2′-hydroxy-5′-methylphenyl)-benzotriazole (Tinuvin P) or a mixture thereof. The UV stabilizers mentioned may be used individually or in the form of a mixture with one or more of the above-mentioned stabilizers in the pressure-sensitive hotmelt adhesives according to the invention.

In a preferred embodiment of the present invention, the pressure-sensitive hotmelt adhesive according to the invention may contain about 0.01 to about 5% by weight, for example about 0.1 to about 3% by weight or about 0.2 to about 2% by weight, of an organic stabilizer. In another preferred embodiment of the present invention, the pressure-sensitive hotmelt adhesive according to the invention contains at least one stabilizer which offers protection against light-induced degradation of the components present in the pressure-sensitive hotmelt adhesive, more especially against UV-induced degradation. In another preferred embodiment of the present invention, the percentage content of such a UV stabilizer in the pressure-sensitive hotmelt adhesive as a whole is about 0.1 to about 1.5% by weight, for example about 0.3 to about 1% by weight.

The pressure-sensitive hotmelt adhesives according to the invention show adequate UV stability even without an organic stabilizer. In a preferred embodiment of the present invention, however, the pressure-sensitive hotmelt adhesive according to the invention contains at least one inorganic particulate compound, as described above, and in addition at least one inorganic UV stabilizer. In another preferred embodiment of the invention, for example, a particulate inorganic compound, as described above, and a mixture of two or more, for example three, four or five, organic stabilizers, for example UV stabilizers, may be present in the pressure-sensitive hotmelt adhesive according to the invention. However, two or more different inorganic particulate compounds and one or more stabilizers, for example one or more UV stabilizers, may also be present in the pressure-sensitive hotmelt adhesive according to the invention.

In this case, the ratio by weight of inorganic particulate compound or the mixture of two or more inorganic particulate compounds to the organic UV stabilizer or to the mixture of two or more UV stabilizers is about 1:100 to about 100:1, for example about 1:50 to about 50:1 or about 1:10 to about 10:1. In another preferred embodiment of the invention, the ratio of inorganic particulate compound to organic UV stabilizer is about 3:1 to about 1:2.

In another preferred embodiment, a pressure-sensitive hotmelt adhesive according to the invention has the following composition for example:

ca. 15 to ca. 40% by weight of an unsaturated polymer,

ca. 35 to ca. 65% by weight of a tackifier resin compatible with the polymer,

0 to about 35% by weight of a plasticizer,

ca. 0.2 to about 4 parts by weight of a stabilizer,

0 to ca. 15% by weight of wax and

ca. 0.5 to ca. 5% by weight of the above-described particulate inorganic compound.

The pressure-sensitive hotmelt adhesive according to the invention can be produced in various ways. For example, the components forming the pressure-sensitive hotmelt adhesive may be mixed in any order in the melt or in a solvent and then cooled or freed from the solvent. However, in the context of the polymerization of the polymer present in the pressure-sensitive hotmelt adhesive, one or more of the components present in the pressure-sensitive hotmelt adhesive may be added before, during or shortly after the polymerization.

In a preferred embodiment of the present invention, the pressure-sensitive hotmelt adhesive is produced by mixing at least one unsaturated polymer and a particulate inorganic compound, the particulate inorganic compound having a mean particle diameter d50 of 0.05 to 300 μm.

In one embodiment of the present invention, for example, the plasticizer is introduced first and then heated to a temperature of about 130 to about 200° C., for example to a temperature of about 150 to about 190° C. The tackifier resin is then dissolved in the plasticizer. The polymer or the mixture of two or more polymers is then introduced into this mixture with stirring until an at least substantially homogeneous mixture is formed. The remaining components, for example UV stabilizer, antiager and the inorganic particulate compound or the mixture of two or more thereof, are then introduced and homogeneously distributed. According to the invention, however, one or more of the steps described above may be carried out in another order, for example one or more of the remaining components, for example UV stabilizer or antiager or the inorganic particulate compound or the mixture of two or more thereof, may be introduced before or during addition of the polymer.

The pressure-sensitive hotmelt adhesives according to the invention may be used for the production of pressure-sensitive adhesive articles. To this end, an article is coated with the molten pressure-sensitive hotmelt adhesive according to the invention, the coating forming a pressure-sensitive adhesive layer on the substrate after cooling of the pressure-sensitive hotmelt adhesive.

Basically, articles suitable for coating with the pressure-sensitive hotmelt adhesive are any articles which have a surface area large enough on the one hand to be coated with the pressure-sensitive hotmelt adhesive and, on the other hand, to be able to enter into a bond with another article on the pressure-sensitive adhesive, coated side, Suitable articles may be spherical, ellipsoidal, conical, cylindrical, square or cubic in shape or may even have any other three-dimensional form as long as the article has a surface that can be coated as described above.

In a preferred embodiment of the present invention, however, web-form or sheet-form articles are coated. Articles such as these are also referred to herein as carrier materials. Web-form or sheet-form articles are, for example, carrier webs or sheets of natural or synthetic materials. These include, for example, paper webs or paper sheets or plastic webs or plastic sheets which can be produced from a number of synthetic polymers.

In a preferred embodiment of the invention, the carrier material is a tape-like material which contains at least one synthetic polymer or a mixture of two or more synthetic polymers. Suitable polymers are, for example, polyethylene, polypropylene, polystyrene, polyvinyl chloride, polyamide, polyester, such as polyethylene terephthalate, or mixtures of two or more of the polymers mentioned.

Accordingly, the present invention also relates to a pressure-sensitive adhesive article at least comprising a carrier material with two or more sides, at least one side being coated with a pressure-sensitive hotmelt adhesive according to the invention and the pressure-sensitive hotmelt adhesive partly or completely covering the at least one side.

If, as is preferably the case, the carrier material is a tape-form carrier material which essentially comprises two coatable sides, both sides may be coated in such a way that they have adhesive properties. In this case, only one side need be coated with the pressure-sensitive hotmelt adhesive according to the invention, although both sides may equally well be coated with a pressure-sensitive hotmelt adhesive according to the invention. In this case, the pressure-sensitive hotmelt adhesives applied to both sides may have identical compositions although pressure-sensitive hotmelt adhesives with different compositions may also be applied to both sides.

The pressure-sensitive adhesive articles according to the invention may be produced, for example, by depositing a molten stream of the pressure-sensitive hotmelt adhesive onto at least one side of the carrier material and cooling the pressure-sensitive hotmelt adhesive. The pressure-sensitive adhesive side present after cooling may then be provided with a cover layer which is easy to remove from the pressure-sensitive hotmelt adhesive, but is joined to it firmly enough to protect the pressure-sensitive hotmelt adhesive against unwanted sticking and soiling in normal use.

Suitable extrusion processes for the production of pressure-sensitive adhesive articles are described, for example, in WO 99/15599. The pressure-sensitive hotmelt adhesive may also be applied by nozzle or slit die and by roller application or screen printing.

The invention is illustrated by the following Examples.

### EXAMPLES

To determine the UV stability of the pressure-sensitive hotmelt adhesive according to the invention, a pressure-sensitive hotmelt adhesive according to the invention and a comparison pressure-sensitive hotmelt adhesive were tested for UV stability.

1. Pressure-Sensitive Hotmelt Adhesive Containing Only Organic UV Stabilizer:

A pressure-sensitive hotmelt adhesive containing UV stabilizer was used for comparison, the pressure-sensitive hotmelt adhesive having the following composition:

30% by weight of a styrene/isoprene/styrene (SIS) copolymer

15% by weight of a naphthenic mineral oil

53% by weight of a hydrocarbon-based tackifier resin

0.6% by weight of Tinuvin 770 DF

1.4% by weight of Irganox 1010 (antioxidant)

2. Pressure-Sensitive Hotmelt Adhesive According to the Invention:

A pressure-sensitive hotmelt adhesive with the following composition was used as the pressure-sensitive hotmelt adhesive according to the invention:

30% by weight of a styrene/isoprene/styrene (SIS) copolymer

15% by weight of a naphthenic mineral oil,

53% by weight of a hydrocarbon-based tackifier resin

0.5% by weight of TiO₂ (Kronos 2056)

0.1% by weight Tinuvin 770 DF

1.4% by weight Irganox 1010 (antioxidant).

Velcro tape samples were coated with adhesives 1 and 2. The samples were exposed to an Osram 300 watt Ultra-Vitalux lamp. The coating weight was 110 g/m².

The samples were tested for their properties immediately after application of the adhesive, after 3 days' UV exposure, after 4 days' UV exposure and after 1000 hours' UV exposure. The following tests were applied:

PSTC-1

The adhesive tape coated with the pressure-sensitive hotmelt adhesive according to the invention and applied to a steel substrate is peeled off at an angle of 180° to the steel substrate. The force required to peel off the adhesive strip is measured.

Loop Tack (to FTM-9)

The loop tack test comprises measuring the adhesive force generated after contact between an adhesive tape coated with the pressure-sensitive hotmelt adhesive according to the invention and a steel substrate with no external application of force during subsequent peeling. To this end, a loop of an adhesive-coated adhesive tape is brought into contact with a steel surface and the force required for subsequent peeling perpendicularly of the steel surface is measured.

PSTC-7

In this test, a tape applied by a pressure-sensitive hotmelt adhesive to the surface of a vertically arranged steel substrate is loaded by a 1 kg weight at an angle of 180° to the surface of the steel substrate. The time taken to remove the adhesive tape completely from the substrate is measured.

The tests described above produced the following results:

| Osram Ultra- | PSTC-1 | Loop | |
|---|---|---|---|
| Vitalux 300 W | [N/25 mm] | Tack | PSTC-7 |
| Immediately | 1. >100 N | 1. 39 N | 1. >168 h |
| | Mat. failure | 2. 22 N | 2. >168 h |
| 3 Days (72 h) | 3. 3N, | 3. 13 N | 3. 4 h |
| | Adhesion failure to | 4. 11 N | 4. 72 h 30 mins. |
| | substrate | | |
| | 4. 40 N | | |
| 7 Days (168 h) | 5. 2 N, | 5. 0 N | 5. 8 mins. |
| | Adhesion failure to | 6. 22 N | 6. 4 h 15 mins. |
| | substrate | | |
| | 6. 45 N | | |
| 1000 h | 1. ./. | 1. ./. | 1. ./. |
| | 2. 27.7 N | 2. 20 N | 2. 6 mins. |
| | Cohesive failure | | |

1. A pressure-sensitive hotmelt adhesive at least containing a polymer with at least one olefinically unsaturated C—C double bond and a particulate inorganic compound, the particulate inorganic compound having a mean particle diameter d50 of 0.05 to 300 μm.

2. A pressure-sensitive hotmelt adhesive as claimed in claim 1, characterized in that the particulate inorganic compound has a rutile structure for a crystal structure.

3. A pressure-sensitive hotmelt adhesive as claimed in claim 1 or 2, characterized in that TiO₂, SnO₂, PbO₂, SiO₂ (stishovite), MnO₂, MgF₂, GeO₂, NbO₂ or a mixture of two or more of the compounds mentioned is present as the particulate inorganic compound.

4. A pressure-sensitive hotmelt adhesive as claimed in any of claims 1 to 3, characterized in that the particulate inorganic compound is present in a quantity of less than 5% by weight.

5. A process for the production of the pressure-sensitive hotmelt adhesive claimed in any of claims 1 to 4, characterized in that at least one unsaturated polymer and a particulate inorganic compound, the particulate inorganic compound having a mean particle diameter d50 of 0.05 to 300 μm, are mixed.

6. A pressure-sensitive adhesive article at least comprising a carrier material with two or more sides, at least one side being coated with the pressure-sensitive hotmelt adhesive claimed in any of claims 1 to 4, characterized in that the pressure-sensitive hotmelt adhesive partly or completely covers the at least one side.

7. A pressure-sensitive adhesive article as claimed in claim 6, characterized in that the carrier material is flexible or transparent or both.

8. A pressure-sensitive adhesive article as claimed in claim 6 or 7, characterized in that the carrier material is a web- or sheet-form material.

9. The use of particulate inorganic compounds with a mean particle diameter d50 of 0.05 to 300 μm for the production of a pressure-sensitive hotmelt adhesive.
